(19) United States
(12) Patent Application Publication
(10) Pub. No.: US 2006/0076070 A1
(43) Pub. Date: Apr. 13, 2006

(54) High pressure rubber hose

(75) Inventor: Kazuhito Yanadori, Hiratsuka-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: THE YOKOHAMA RUBBER CO., LTD.

(21) Appl. No.: 11/244,162

(22) Filed: Oct. 6, 2005

(30) Foreign Application Priority Data
Oct. 7, 2004 (JP) 2004-294666

(51) Int. Cl. F16L 11/00

(52) U.S. Cl. 138/126

(57) ABSTRACT

Provided is a high pressure rubber hose in which at least one reinforced layer formed of fiber cords is inserted. The fiber cords are formed of polybutylene terephthalate fibers having, under a load of 2 cN/dtex, an intermediate elongation in a range between 10% and 15% inclusive.

### BACKGROUND OF THE INVENTION

The present invention relates to a high pressure rubber hose, and more specifically, the present invention relates to a high pressure rubber hose for which an expansion characteristic attributable to pulsation of hydraulic oil, and durability are compatibly achieved. In particular, the present invention relates to a high pressure rubber hose preferable as a power steering hose.

A power steering mechanism of an automobile is driven by a process where hydraulic oil is pumped thereinto through a high pressure rubber hose from an oil pressure pump such as a gear pump. Hereinafter, a high pressure rubber hose thus used in a power steering mechanism will be referred to as a power steering hose.

A power steering hose generates vibrations since expansion and contraction are repeated due to a pulsation pressure of an oil pressure pump. These vibrations of the power steering hose are transmitted to a car cabin through a car body frame, and if a frequency of the vibrations exceeds a primary resonance point, air in the cabin resonates with the vibrations to generate a resonance sound, which sometimes is perceived as noise and causes discomfort to a passenger. Such a characteristic of a hose that vibrations of a power steering hose thus generates a resonance and causes discomfort is called an expansion characteristic, or a noise, vibration and harshness characteristics (NVH characteristics).

A power steering hose is designed, generally for the purpose of absorbing a pulsation pressure generated by an oil pressure pump in the above manner, in order that adequate expansion can be performed. The larger an amount of expansion of the hose is, the more the expansion contributes to suppression of vibrations. However, if an amount of expansion is too large, that causes excessive distortion to materials of the hose, whereby there arises a problem that durability of the hose is reduced. More specifically, in a high pressure rubber hose, there is a mutually conflicting relation between the expansion characteristic (or NVH characteristics) attributable to pulsation, and the durability, and compatible achievement of these characteristics has been an object very difficult to achieve.

Japanese patent application Kokai publication No. Hei7-42879 proposes that, for a high pressure rubber hose for which an expansion characteristic and durability are compatibly achieved, in a case where nylon 66 fibers are used for fiber cords of a reinforcement layer buried in the hose, an intermediate elongation of the nylon 66 fibers should be 9.0 to 10.0% under a load of 4.5 kgf/1890 d (44 N/2100 dtex), which is nearly equal to 2.3 g/d (2 cN/dtex). By applying the nylon 66 fibers thus determined to have a high intermediate elongation to the reinforcement layer of the hose, compatible achievement of an expansion characteristic and durability thereof is made possible.

However, with respect to a users' demand for durability of a high pressure rubber hose, users consider that the higher the durability of a hose is, the more preferable the hose is, and hence they anticipate further durability enhancement.

### SUMMARY OF THE INVENTION

An object of the invention is to provide a high pressure rubber hose for which an expansion characteristic and durability are compatibly achieved with both being in excellent states.

For achieving the above object, a high pressure rubber hose of the present invention is a high pressure rubber hose in which at least one reinforced layer formed of fiber cords is inserted, characterized in that the fiber cords are formed of polybutylene terephthalate fibers having, under a load of 2 cN/dtex, an intermediate elongation in a range between 10% and 15% inclusive.

According to the present invention, by thus using highly elongative polybutylene terephthalate fibers having an intermediate elongation of 10% or above for fiber cords of a reinforced layer, an initial modulus of the reinforced layer is made low and thereby an expansion amount of a rubber hose is made larger. Accordingly, excellent expansion characteristic or NVH characteristics can be obtained. Additionally, by setting an upper limit of 15% to the intermediate elongation of the fiber cords, it becomes possible to suppress reduction in durability of the hose attributable to repeated pulsation of hydraulic oil.

### BRIEF DESCRIPTION OF THE DRAWING

FIG. 1 is a partially cut-way perspective view of an example of a high pressure rubber hose according to the present invention.

### DETAILED DESCRIPTION OF THE INVENTION

In the present invention, a high pressure rubber hose is structured by inserting a reinforcement layer formed of fiber cords, between an inner rubber layer and an outer rubber layer. It is only necessary to provide at least one reinforcement layer inside the high pressure rubber hose, and two or more of reinforcement layers may be arranged according to need. In the case where a plurality of the reinforcement layers are provided, an intermediate rubber layer may be arranged between each adjacent two of the reinforcement layers, or may not be arranged at all.

Although a structure of the reinforcement layer is not particularly limited, preferably, a structure may be obtained by interweaving the fiber cords in a braided structure. The braided cords are formed in a cylindrical shape, and the cylindrical shape is inserted into the hose in order that it can be coaxial with the hose. A braiding angle with respect to an axial direction of the hose is preferably in a range of 47 to 53 degrees, and more preferably in a range of 49 to 51 degrees. Additionally, as a structure of the reinforcement layer, instead of a braided structure, it is also possible to use a structure obtained only by arraying a plurality of fiber cords so as to be parallel with one another. It is preferable to tilt a direction in which the arrayed fiber cords extend with respect to the axial direction of the hose, and to insert the arrayed fiber cords spirally. It is also preferable, in a case where a plurality of the reinforcement layers are provided, to make two arrays of the arrayed fiber cords in adjacent two of the reinforcement layers to extend in opposite directions to cross with each other.

As the fiber cords forming the reinforcement layer, polybutylene terephthalate fibers are used. Furthermore, as the polybutylene terephthalate fibers, used are the ones having a characteristic that an intermediate elongation is between 10% and 15% inclusive under a load of 2 cN/dtex. With the polybutylene terephthalate fibers having an intermediate elongation less than 10% under a load of 2 cN/dtex, pulsation of hydraulic oil cannot be efficiently absorbed, and consequently a vibration suppression effect of the hose is reduced. Therefore, a frequency of vibrations occurring when the hose transports the hydraulic oil exceeds a primary resonance point, and thereby a resonance sound is produced inside a car cabin. On the other hand, with the polybutylene terephthalate fibers having an intermediate elongation exceeding 15%, durability of the hose is reduced.

As the polybutylene terephthalate fibers used in the present invention, the one having a breaking elongation of 25% or less in addition to the above intermediate elongation is preferable. With the above breaking elongation and intermediate elongations, durability and a creep characteristic of the hose can be further improved. Although a lower limit of the breaking elongation is not particularly limited, that is naturally determined in its relation with the lower-limit figure (10%) of the intermediate elongation.

Additionally, it is preferable that breaking strength of the polybutylene terephthalate fibers be 5.3 cN/dtex or above. With the polybutylene terephthalate fibers having breaking strength of 5.3 cN/dtex or above, pressure resistance of the hose can be secured. Although an upper limit of the breaking strength is limited in terms of manufacturing technology as a matter of course, in a range of possible manufacturing, the higher the breaking strength is, the better it is.

As the polybutylene terephthalate fibers for obtaining the abovementioned fiber characteristics, they may be formed of highly polymerized polybutylene terephthalate based polymer which preferably includes polybutylene terephthalate units of 90 mol % or more, and more preferably includes polybutylene terephthalate units of 95 to 100 mol %, and whose intrinsic viscosity is 1.0 or above, more preferably 1.2 or above. With polybutylene terephthalate whose intrinsic viscosity is less than 1.0, it becomes difficult to obtain the above-mentioned strength and elongation characteristics.

The intrinsic viscosity here is intrinsic viscosity found in the following manner. After a resultant of adding 25 ml of orthochlorophenol to 0.125 g of the polymer has been heated at a temperature of 120° C. for 30 minutes to be dissolved, relative viscosity of the resultant is measured by using an Ostwald viscometer and then the intrinsic viscosity is found by using a conversion table.

In the polybutylene terephthalate based polymer, a polymer component which comprise less than 10 mol % thereof is not particularly limited as long as the polymer component is one having an ester formation property. As examples of such a polymer component, as well as terephthalic acid, propylene glycol and propylene oxide, ethylene glycol, ethylene oxide, butylene glycol, isophthalic acid, naphthalene dicarboxylic acid, diphenyl dicarboxylic acid and sodium-5-sulphonate isophthalate, and the like can be cited.

As described above, the polybutylene terephthalate fibers used in the invention are high in intermediate elongation, and accordingly, a number of twists given to the fiber cords may be zero (0) meaning that no twist is given, or may be a small number. By thus limiting the number of twists to be zero or a small number, it becomes possible to make the most of mechanical characteristics of the polybutylene terephthalate fibers, and to further enhance various characteristics of the rubber hose. As a concrete example of the number of twists, a range of 0 to 10 times/10 cm is preferable, and 0 to 7 times/10 cm is more preferable.

Kinds of rubber used for the inner rubber layer, outer rubber layer and intermediate rubber layer are not particularly limited, and kinds conventionally used for a high pressure rubber hose are all usable. Among those rubber kinds, for the inner and outer rubber layers in particular, it is preferable to use chlorosulfonate polyethylene, chlorinated polyethylene, acrylonitrile butadiene rubber or the like, and for the intermediate rubber layer, it is preferable to use acrylonitrile butadiene rubber.

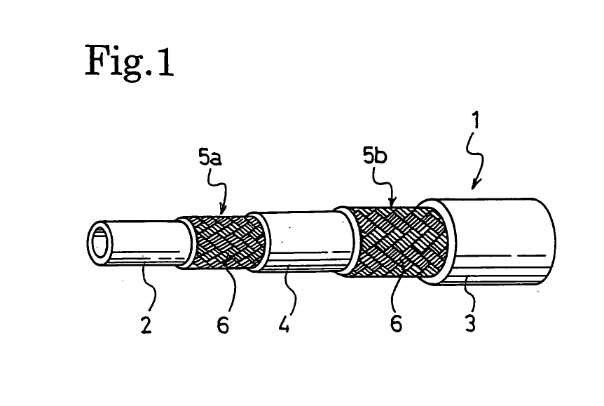

FIG. 1 is a partially cut-way perspective view of an example of a high pressure rubber hose according to the present invention.

In FIG. 1, a high pressure rubber hose 1 is formed by arranging two reinforcement layers 5a and 5b between an inner rubber layer 2 and an outer rubber layer 3, and by further arranging an intermediate rubber layer 4 between the reinforcement layers 5a and 5b. For each of the reinforcement layers 5a and 5b, what is obtained by braiding polybutylene terephthalate fiber cords 6 are used, and for the polybutylene terephthalate fiber cords 6, used are cords having an intermediate elongation in a range between 10% and 15% inclusive under a load of 2 cN/dtex.

The high pressure rubber hose thus structured can be compatibly provided with an excellent expansion characteristic (or NVH characteristics) and durability, when it is used as a power steering hose.

### EXAMPLES

High pressure rubber hoses of seven types were respectively manufactured with common conditions of being an inner diameter of 10 mm, an outer diameter of 19 mm, the hose structures shown in FIG. 1, in which, as rubber materials, acrylonitrile butadiene rubber is used for inner rubber and intermediate rubber, and chlorosulfonated polyethylene rubber is used for outer rubber. The seven types were made different with one another, as shown in Table 1, in kind of fiber cords constituting two reinforcement layers, in intermediate elongation under a load of 2 cN/dtex, and in breaking elongation under the same load (Examples 1 to 3, and Comparative Examples 1 to 4).

Note that, in Table 1, “PBT”, “PET,” and “N66” respectively stand for polybutylene terephthalate fibers with a 1670 dtex/2 structure, polyethylene terephthalate fibers with a 1670 dtex/2 structure, and nylon 66 fibers with a 2100 dtex/1 structure. With respect to braided structures, the one using the PBT or PET fibers was formed with 24 yarns where each yarn was formed of three cords (two layers each formed of this structure were used for each hose), and the one using the nylon 66 fibers was formed with 24 yarns where each yarn was formed of four cords (two layers each formed of this structure were used for each hose).

With respect to each of the high pressure rubber hoses of the seven types, a NVH characteristics and durability were measured, and results of the measurements are included in Table 1.

NVH Characteristics:

After each of the test hoses in a length of 400 mm was filled with hydraulic oil, pulsation pressure of 5±0.1 MPa was applied to the hose under a temperature of 50° C. Then, a primary resonant point was found when a frequency of the pulsation pressure was changed.

In assessments of NVH characteristics, a hose having a primary resonance point of 130 Hz or lower was judged as an acceptable product which does not generate an uncomfortable sound, and a hose having a primary resonance point exceeding 130 Hz was judged an unacceptable product which generates an uncomfortable sound.

Durability:

After each of the test hoses in a length of 400 mm was filled with hydraulic oil, impact pressures of a pressure level of 8 MPa were repeatedly applied to the hose under a temperature of 150° C. Then, a number of the repeated pressure applications until the hose was destroyed was measured.

In assessments of durability of hose, a hose was judged as an acceptable product if the hose was not destroyed at the time when 400,000 repeated pressure applications had been performed on the hose, and a hose was judged as an unacceptable product if the hose was destroyed at the time before 400,000 repeated pressure applications were performed on the hose.

TABLE 1

| | | | | Comparative | Comparative | Comparative | Comparative |
|---|---|---|---|---|---|---|---|
| | Example 1 | Example 2 | Example 3 | Example 1 | Example 2 | Example 3 | Example 4 |
| Fiber kind | PBT | PBT | PBT | PBT | PBT | PET | N66 |
| Twist structure | 5 times/10 cm | 5 times/10 cm | No | 5 times/10 cm | 5 times/10 cm | 5 times/10 cm | No |
| | S twist | S twist | twist | S twist | S twist | S twist | twist |
| | one-side twist | one-side twist | | one-side twist | one-side twist | one-side twist | |
| Intermediate elongation (%) | 13.8 | 14.5 | 12.2 | 15.2 | 9.8 | 1.8 | 12.0 |
| Breaking intensity (cN/dtex) | 5.4 | 5.4 | 5.4 | 5.3 | 5.5 | 6.6 | 7.3 |
| Breaking elongation (%) | 22.3 | 24.9 | 23.2 | 26.1 | 18.8 | 15.1 | 25.1 |
| NVH characteristics (Hz) | 125 | 123 | 128 | 121 | 132 | 139 | 109 |
| Durability (10,000 times) | 40 | 40 | 40 | 38 | 40 | 40 | 15.1 |

(Note)
In Table 1, “PBT”, “PET,” and “N66” respectively stand for polybutylene terephthalate, polyethlene terephthalate, and nylon 66.1

What is claimed is:

1. A high pressure rubber hose into which at least one reinforcement layer formed of fiber cords, wherein the fiber cords are formed of polybutylene terephthalate fibers having, under a load of 2 cN/dtex, an intermediate elongation in a range between 10% and 15% inclusive.

2. The high pressure rubber hose according to claim 1, wherein the polybutylene terephthalate fibers are formed of a highly polymerized polybutylene terephthalate based polymer which includes polybutylene terephthalate units of at least 90 mol % and whose intrinsic viscosity is at least 1.0.

3. The high pressure rubber hose according to any one of claims 1 and 2, wherein breaking elongation of the polybutylene terephthalate fibers is not more than 25%, and breaking strength thereof is not less than 5.3 g/dtex.

4. The high-pressure rubber hose according to any one of claims 1 and 2, wherein a number of twists to the polybutylene terephthalate fibers is any one of 0 to 10 times/10 cm.

5. The high pressure rubber hose according to any one of claims 1 and 2, wherein the at least one reinforcement layer is formed in a braided structure formed of the fiber cords, and a braiding angle of the fiber cords with respect to an axial direction of the hose is in a range of 47 to 53 degrees.

6. The high pressure rubber hose according to any one of claims 1 and 2, wherein the high pressure rubber hose is a power steering hose.
